(19) United States
(12) Patent Application Publication
(10) Pub. No.: US 2026/0328672 A1
(43) Pub. Date: Oct. 22, 2026

(54) METHODS AND SYSTEMS FOR CO-LINEAR LASER SCANNING

(71) Applicants: NanoCellect Biomedical, Inc., San Diego, CA (US); The Regents of the University of California, Oakland, CA (US)

(72) Inventors: Joe HOLLAND, San Diego, CA (US); Ivan GAGNÉ, San Diego, CA (US); Rui TANG, San Diego, CA (US); Lin XIA, San Diego, CA (US); Yu-Hwa LO, San Diego, CA (US)

(21) Appl. No.: 19/391,224

(22) Filed: Nov. 17, 2025

Related U.S. Application Data
(63) Continuation of application No. PCT/US2024/029941, filed on May 17, 2024.
(60) Provisional application No. 63/503,430, filed on May 19, 2023.

(51) Int. Cl. G01N 15/1434; G01N 15/14; G01N 15/1404; G01N 15/149

(52) U.S. Cl. CPC G01N 15/1434; G01N 15/1404; G01N 15/149; G01N 2015/142; G01N 2015/1493

(57) ABSTRACT

Provided are systems and method for the imaging of a particle in motion using multiple lasers in a confirmation that allows for association of the image data of each laser.

### CROSS REFERENCE

This application is a continuation of International Application No. PCT/US2024/029941, filed May 17, 2024, which claims the benefit of U.S. Provisional Application No. 63/503,430, filed May 19, 2023, all of which are incorporated by reference herein in their entirety.

### BACKGROUND

The present disclosure relates to an image-assisted particle sorter such as a flow cytometer. It is desirable to make image-assisted sorting decisions for particles, spheroids, beads and other microparticles in addition to fluorophore intensity-driven sorting decisions. In some instances, it is desirable to combine different types of particle images. For example, a user might wish to combine different images, such as brightfield and epifluorescence. Such combined images can be used in various analyses, such as localization of cellular components, cell-to-cell interactions, drug interaction, and much more. In some instances, more than one illumination laser wavelength is required. For example, an epi-fluorescent image may require a different excitation laser wavelength than a brightfield image. Conventional particle sorting technologies are purely based on the fluorescent and/or scattering intensity but have difficulty scanning with multiple lasers in order to allow for multiple fluorescent signals to be collected in the same register. Fluorescence-activated particle sorting can only resolve particle-to-particle variations in fluorescence and optical scattering. Thus, improvements in methods and instruments for the simultaneous production of images from multiple lasers are desired.

### SUMMARY

In some aspects provided herein is a particle sorting system that may comprise an imaging device. The imaging device may include a first beam scanner configured to scan a first beam along a first direction to obtain a first particle image data, including fluorescent information or label-free particle image information of a particle. The first beam is configured to be applied to the particle flowing in a channel along a second direction with an angle to the first direction. The imaging device may also include a second beam scanner configured to scan a second beam along a first direction to obtain a second particle image data, including fluorescent information or label-free particle image information of a particle. The second beam is configured to be applied to the particle flowing in a channel along a second direction with an angle to the first direction. The first beam and the second beam are configured to be applied to the particle flowing in the channel separately.

A particle may be a cell. In other examples, a particle may be a spheroid, organoid, bead, or a mixture of any of the above.

Provided herein is a particle sorting system that may comprise a data processing and control device in communication with the imaging device. The data processing and control device may include a processor configured to process the particle images generated by the first beam and the second beam obtained by the imaging device to determine one or more properties associated with the particle from the processed particle image data. The data processing and control device may produce a control command based on a comparison of the determined one or more properties with a sorting criterion. The control command is configured to be produced during the particle flowing in the channel and may be indicative of a sorting decision determined based on one or more attributes ascertained from the particle image data.

In some aspects, provided herein is a particle sorting system that may comprise a particle sorting device in communication with the imaging device and the data processing and control device. The particle sorting device may include one or more output paths branching from the channel in which the particle flows, and the particle sorting device is configured to direct the particle into one of the two or more output paths based on the control command.

In some embodiments, the particle sorting system may comprise a first beam scanner and a second beam scanner that comprise a first Acousto-Optic Deflector (AOD) beam scanner and a second Acousto-Optic Deflector (AOD) beam scanner. In some embodiments, the first AOD beam scanner and the second AOD beam scanner may be operatively coupled with a first laser light source and a second laser light source respectively. The first AOD beam scanner and the second AOD beam scanner may be configured to direct an input light toward the particle in the channel. In some embodiments, the imagining device may further comprise an aperture that may be operable to block the first beam or the second beam.

In some embodiments, one of the beams may be emitted from a 488 nm laser and the second beam may be from a 561 nm laser. In some embodiments a plurality of beams may be emitted from a 355 nm, 405 nm, 488 nm, 532 nm, 561 nm, or 633 nm lasers combined in any permutation.

In some embodiments, the first AOD and the second AOD may be separably programmable, by the data processing unit, to generate a first scanning frequency and a second scanning frequency. In some embodiments, the first scanning frequency or second scanning frequency may be about 1000 kHz. In some embodiments, the first AOD and the second AOD may be programmable, by the data processing unit, to generate combined scanning frequency of about 500 kHz to about 30 kHz, In some embodiments, the data processing and control device may be further configured to process particle image data from the first laser and particle image data from the second laser to generate combined particle image data. In some embodiments, the combined particle image data may be generated by combining the first particle image data with the second particle image data. In some embodiments, the imaging system may include photodetectors configured to generate a corresponding time-domain signal based on a detection of light emitted, scattered, or absorbed by the particle. In some embodiments, the processor of the data processing and control device may be further configured to convert the first particle image data and second particle image data obtained from the imaging system into an initial two-dimensional particle image and perform an image resizing operation to correct an error caused by an effect of a travelling speed of the particle. In some embodiments, the imaging system may further comprise a one or more passive optical components, selected from a group consisting of, but not exclusively, one or more lenses, cylindrical lens, mirrors, dichroic filters, prisms, and spatial filters. In some embodiments, the imaging system may further comprise a third beam scanner configured to scan a third beam along a first direction to obtain a third particle image data including fluorescent information or label-free image information of a particle. The third beam is configured to be applied to the particle flowing in a channel along a second direction with an angle to the first direction. The first beam, the second beam, and the third beam are configured to be applied to the particle flowing in the channel separately.

In some aspects provided herein is a method for imaging of moving particles. The method for imaging of moving particles may comprise moving a particle along a first direction and generating a plurality of light beams from a plurality of lasers. Each light beam may be generated by exactly one laser and the plurality of light beams may be passed through a plurality of Acousto-Optic Deflectors (AODs). In some embodiments, each light beam may pass through exactly one AOD. In some embodiments the plurality of light beams may be deflected with the plurality of AODs such that the plurality of light beams scan in a second direction at an angle to the first direction at a programable frequency. In some embodiments, the plurality of beams may scan the particle at a single point, such that only one light beam of the plurality of light beams scans the single point at a given time. In some embodiments, the method may further comprises moving a plurality of apertures to block the plurality of beams when the plurality of beams may be not scanning the single point. In some embodiments, each AOD of the plurality of AODs may be individually programable to scan at a frequency. In some embodiments, the frequency of the scan may be about 150 kHz. In some embodiments, the method may further comprise an effective AOD frequency, wherein the effective AOD frequency may be the sum of the frequency of each of the plurality of AODs. In some embodiments, the effective AOD frequency may be about 300 kHz. In some embodiments, the method may comprise two lasers. In some embodiments, the method may further comprise detecting the optical signals of the plurality of light beams in a plurality of photodetectors.

In some embodiments, the method may further comprise processing the optical signals to create combined image data of the particle. In some embodiments, the method may further comprise determining one or more properties associated with the particle from the processed combined image data. In some embodiments, the processing of the optical signal may further comprise performing an image resizing operation to correct an error caused by an effect of a travelling speed of the particle. In some embodiments, a velocity of the motion of the particle moving in the first direction may be determined using the optical signals. In some embodiments, generating a plurality of light beams may further comprise one or more passive optical components, selected from a group consisting of, but not exclusively, one or more cylindrical lens, lens, mirrors, dichroic filters, prisms, and spatial filters.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 depicts an exemplary system 100 that allows for co-linear scanning of a particle traveling through a flow cell 110.

FIG. 2 depicts a side view of scanning as a particle flows through a flow cell using a focused beam of light.

FIG. 3A depicts a combined Acousto-Optic Deflector diagram in which the frequency transmitted to each AOD may be varied such that the deflection of a laser passing through each of the AODs scans across a particle 302. FIGS. 3B-3D depict a particle 302 as it passes though the detection area and may be alternately scanned by each laser. The particle 302 motion may be exaggerated in vertical direction for illustrative purposes. At the times highlighted by 301, the AODs for both lasers may simultaneously have a frequency applied.

FIG. 4A depicts a fast-moving particle as it passes a scan line and a graphic showing the relative signal intensity over time (scan number).

FIG. 4B depicts a slower moving particle as it passes a scan line and a graphic of the relative signal intensity over time.

FIG. 5 depicts an example detector array of PMTs to detect signals of co-linear lasers.

FIG. 6 depicts an illustration of a possible implementation of speed detection optics in a system with 2 colinear scanning lasers.

FIG. 7 depicts a data flow diagram of one execution of the present disclosure.

FIG. 8 depicts a flow chart of a Data processing workflow and control system of one execution of the present disclosure.

FIG. 9 depicts one example of how an image can be constructed.

FIG. 10 depicts one way particle features can be determined.

### DETAILED DESCRIPTION

While various embodiments of the invention have been shown and described herein, it will be obvious to those skilled in the art that such embodiments are provided as examples only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” +“ ”greater“ than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Certain inventive embodiments herein contemplate numerical ranges. When ranges are present, the ranges include the range endpoints. Additionally, every sub range and value within the range is present as if explicitly written out. The term “about” or “approximately” may mean within an acceptable error range for the particular value, which will depend in part on how the value is measured or determined, e.g., the limitations of the measurement system. For example, “about” may mean within 1 or more than 1 standard deviation, per the practice in the art. Alternatively, “about” may mean a range of up to 20%, up to 10%, up to 5%, or up to 1% of a given value. Where particular values are described in the application and claims, unless otherwise stated the term “about” meaning within an acceptable error range for the particular value may be assumed.

Disclosed are methods, devices and applications pertaining to particle imaging systems and methods. The disclosed technology provides high throughput of flow cytometer and high information content of microscopy by obtaining particle image information using controlled optical beams. In some implementations, particle image information of fast-traveling particles may be accessed by scanning an optical beam across an object by a fast beam scanner such as an Acousto-Optic Deflector (AOD) as the particle travels past the field of view, to enable greater particle information collection. Some implementations of the disclosed technology also provide reconstructing the particle image to reduce and prevent an error occurred during the obtaining the particle image. According to the disclosed techniques, it may be possible to provide particle sorting techniques which can operate quickly while providing more accurate and reliable results.

The disclosed technology provides a sorting and classification system possessing the high throughput of flow cytometer and high information content of microscopy. Cell populations if interest may be sorted in real-time based on high-content information extracted from the cell images.

The disclosed technology provides particle sorting techniques enabling real-time acquisition of fast-traveling particle images using multiple beam scanning devices such as an Acousto-Optic Deflector (AOD) beam scanner to allow higher throughput scanning. Other implementations may be also possible. The design of the particle sorting system suggested can support a throughput of over 10,000 particle/s, which may be several orders of magnitude greater than any microscopy-based cell isolation systems such as laser micro dissection systems. In some embodiments, the particle throughput ranges from less than 1 to 100 sorting events per second. In some embodiments the particle throughput ranges from 1/sec and 1000/sec. In some embodiments image production and analysis can be performed at a rate ranging from 1 and 5000 particles per second.

### Overview of System

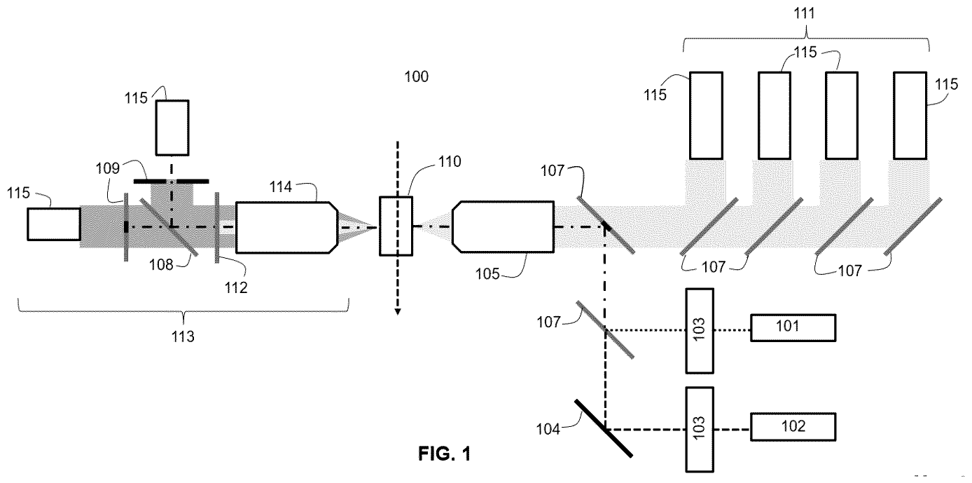

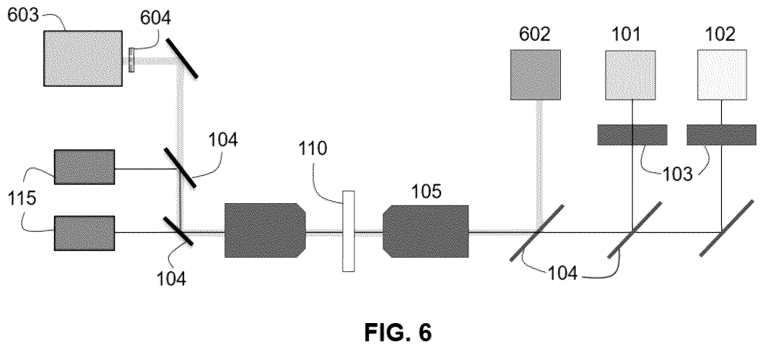

FIG. 1 shows a diagram of an example embodiment of a particle sorting system 100 in accordance with the present technology. The system 100 includes multiple lasers 101 and 102 which may be controlled by multiple independent AODs 103 that deflect each of the laser beams 101 and 102. The laser beams may be transmitted through the system 100 by various lenses (not shown) and mirrors 104 and 107. The mirrors may in some cases be bandpass filters, fully reflective, or partially reflective among others. The laser beams may be then transmitted through an objective 105 and focused through a flow cell 110. The transmitted, scattered, speed detection (FIG. 6), and fluorescent signals may be separated by optical elements 111 and 113 and detected by photodetectors 115.

To support various functions of the data processing and control unit, the memory can store information and data, such as instructions, software, values, images, and other data processed or referenced by the processor. For example, various types of random-access memory (RAM) devices, read only memory (ROM) devices, flash memory devices, and other suitable storage media can be used to implement storage functions. In some implementations, the data processing and control unit includes an input/output (I/O) unit to interface the processor and/or memory to other modules, units or devices. In some embodiments, for mobile computing devices, the data processing and control unit includes a wireless communications unit, e.g., such as a transmitter (Tx) or a transmitter/receiver (Tx/Rx) unit. For example, in such embodiments, the I/O unit can interface the processor and memory with the wireless communications unit, e.g., to utilize various types of wireless interfaces compatible with typical data communication standards, which can be used in communications of the data processing and control unit with other devices, e.g., such as between the one or more computers in the cloud and the user device. The data communication standards include, but are not limited to, Bluetooth, Bluetooth low energy (BLE), Zigbee, IEEE 802.11, Wireless Local Area Network (WLAN), Wireless Personal Area Network (WPAN), Wireless Wide Area Network (WWAN), WiMAX, IEEE 802.16 (Worldwide Interoperability for Microwave Access (WiMAX)), 3G/4G/LTE cellular communication methods, and parallel interfaces.

In some implementations, the data processing and control unit can interface with other devices using a wired connection via the I/O unit. The data processing and control unit can also interface with other external interfaces, sources of data storage, and/or visual or audio display devices, etc. to retrieve and transfer data and information that can be processed by the processor, stored in the memory, or exhibited on an output unit of a display device or an external device.

The particle sorting system can include multiple data processing units and control units, each performing the respective operations, e.g., detecting the waveforms, reconstructing the particle images, and extracting particle image features and generating criteria. If the image-guided particle sorting system includes multiple units and control units, those multiple units can be located at one site or distributed across multiple sites and interconnected by a communication network.

### Optical Configuration (Particle Imaging Operation)

The optical configuration of the cell imaging system includes an AOD 103 and a laser illumination source 101 and 102 that may be configured to direct light toward particles (e.g., cells) flowing in a channel 110. The AOD may be coupled to the laser illumination source to deflect a laser beam. The laser illumination source coupled with the AOD may create a scanning beam with a small (<2 um diameter) spot size after focusing to provide an input or probe light at the illumination area of the microfluidic device, and to obtain images of the illuminated particles in the illumination area. Thus, the laser illumination source and the AOD may operate together to generate fluorescent signals, optical scatter signals, and/or optical transmission signals. The AOD can be driven by a frequency and amplitude-modulated drive signal generated by a waveform synthesizer. The amplitude of the drive signal can be modulated to control the brightness of the illumination sources at the selected deflection angle or location during the scan. The drive signals amplitude can be modulated to control the illumination sources brightness at the selected deflection angle or location during the scan. When the beam scans across the particles, the fluorescent signals, which may include cell fluorescence information, can be detected. In addition, when the beam hits a cell, a part of the light is scattered. Most of the remaining light is either absorbed or transmitted through the cell. The transmitted light can form optical transmission signals, which include transmission image information. The scattered part can create forward and backward scattered signals, which include imaging information. The scanned laser beam spot that excites fluorescence or transmits through the cell can produce a time domain signal at the output of a photodetector in the form of current or voltage. In some implementations, the laser illumination source may be a 488 nm wavelength laser. The 488 nm wavelength laser illumination can be used to generate transmission images and fluorescence images via excitation of fluorophores. In some embodiments, the laser illumination source may be a 561 nm laser. In some embodiments, the laser illumination source may be a 355 nm, 405 nm, 488 nm, 532 nm, 561 nm, or 633 nm laser, or combined in any permutation.

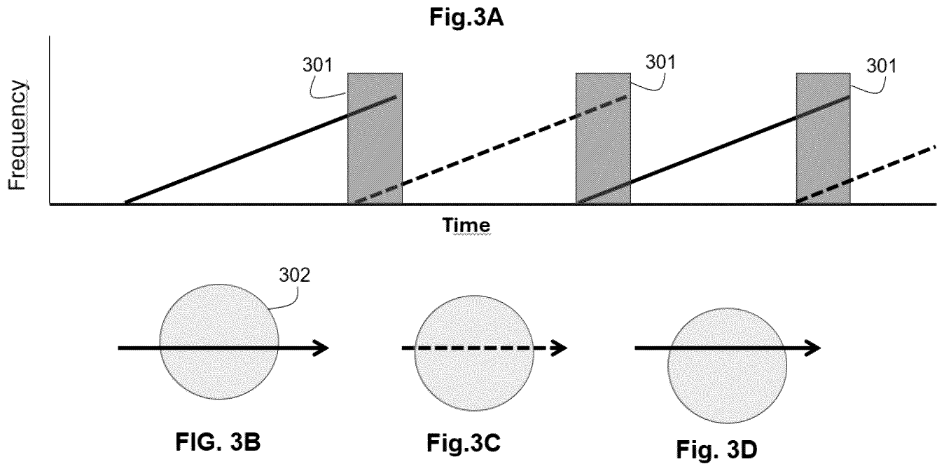

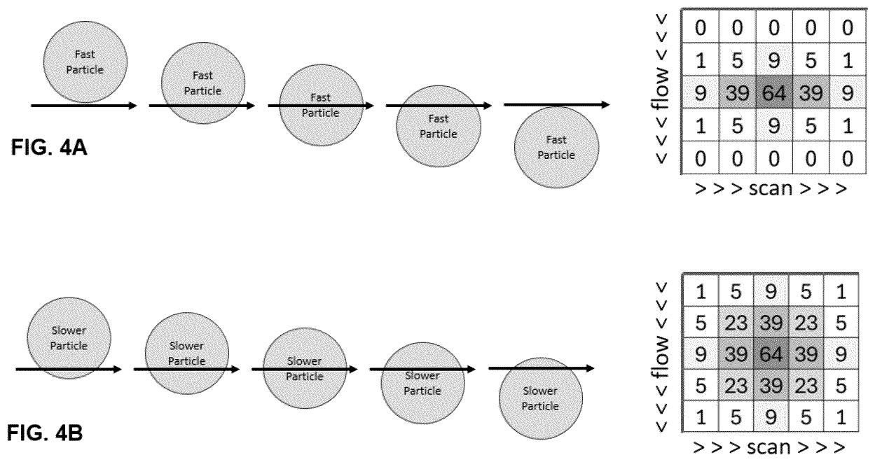

In most embodiments, the scanning laser scans may be separated temporally so that only a single laser is illuminating the particle at a particular time. In some embodiments, the temporal separation may be achieved by completing a single scan in a direction across the particle with the first laser FIG. 3A, then, completing a scan with a second laser FIG. 3B. In some embodiments additional scans may be completed with additional lasers. In some embodiments, the temporal separation may be achieved by pulsing each laser in a staggered pattern so that only a single laser of the plurality may be illuminating the particle at a single time.

In some embodiments, the system comprises multiple lasers such as a 488 nm laser and a 561 nm laser. In some embodiments, the system may comprise a plurality of lasers. The plurality of lasers may be 1, 2, 3, 4, 5, 6, or more lasers. The system may also include a plurality of AOD or similar devices for controlling the angle of the plurality of lasers. Each AOD may be controlled separately such that each laser may be scanned across the flow particle individually, allowing for the collection of fluorescent data without the interference of other light sources or fluorescent emissions. The system may also further include a mechanism that can be operated to block any laser that may not be currently the designated scanning laser. The blocker may be an opaque material position at either end of the aperture such that a laser signal may be only transmitted through the aperture when it may be actively being scanned across the flow cell.

Each individual AOD or similar device may be programed with an individual scan rate. The scan rate may be at least 1 kilohertz (kHz), 25 kHz, 50 kHz, 75 kHz, 100 kHz, 125 kHz, 150 kHz, 175 kHz, 200 kHz, 225 kHz, 250 kHz, 275 kHz, 300 kHz, 325 kHz, 350 kHz or more. The scan rate may be less than 350 kHz, 325 kHz, 300 kHz, 275 kHz, 250 kHz, 225 kHz, 200 kHz, 175 kHz, 150 kHz, 125 kHz, 100 kHz, 75 kHz, 50 kHz, or less. The scan rate may be defined by a range of any of the previous values. Each AOD may have the same scan rate or a different scan rate.

The system may have an effective scan rate. The effective scan rate may be defined as the sum of the frequencies of each of the individual scans. Thus, each effective scan may comprise 1, 2, 3, 4, 5, 6, 7, 8, or more individual scanning operations. The effective scan rate may be at least 1 kilohertz (kHz), 25 kHz, 50 kHz, 75 kHz, 100 kHz, 125 kHz, 150 kHz, 175 kHz, 200 kHz, 225 kHz, 250 kHz, 275 kHz, 300 kHz, 325 kHz, 350 kHz, 375 kHz, 400 kHz, 425 kHz, 475 kHz, 500 kHz, 525 kHz, 550 kHz, 575 kHz, 600 kHz, 650 kHz, 700 kHz, 750 kHz, 800 kHz, 900 kHz, 1,000 kHz, or more. The scan rate may be less than 1,000 kHz, 900 kHz, 800 kHz, 750 kHz, 650 kHz, 600 kHz, 575 kHz, 550 kHz, 525 kHz, 500 kHz, 525 kHz, 500 kHz, 475 kHz, 425 kHz, 400 kHz, 375 kHz, 350 kHz, 325 kHz, 300 kHz, 275 kHz, 250 kHz, 225 kHz, 200 kHz, 175 kHz, 150 kHz, 125 kHz, 100 kHz, 75 kHz, 50 kHz, or less. The effective scan rate may be defined by a range of any of the previous values. The system may calculate the individual scan rate based upon a user defined effective scan rate. The effective scan rate may be determined by the number of lasers. The effective scan rate may be determined by the flow speed, the number of particles, the type of particle, or any combination thereof.

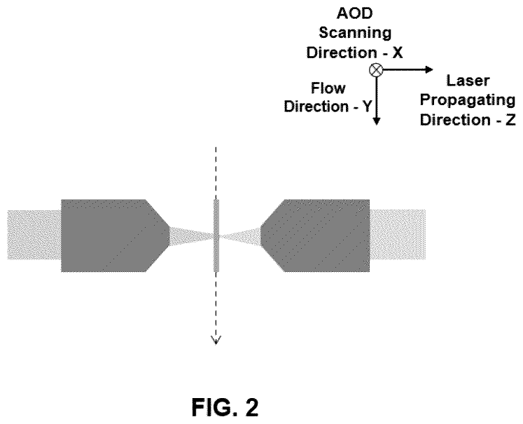

FIG. 2 shows examples of a beam scanning direction and a particle travelling direction that may be employed in a particle imaging system included in an particle sorting system based on some implementations of the disclosed technology. The flow direction of the particles may be along the Y-axis and the beam scanning proceeds in the X-axis. The laser spot may be scanned in the Z-direction driven by the AOD, while the particle flows through the channel. The flow of the particle provides a slow-axis (Y-axis) information, and the beam scanning provides a fast-axis (e.g., X-axis) information, which enables the production of two-dimensional particle images over the Y-Z plane where Z-axis may be the beam scanning direction and Y-axis may be the particle flow direction. Since the AOD performs only one-dimensional scanning at a quite high speed it may be possible to collect multiple scans as the particle flows by the field of view. Although FIG. 1 shows the AOD as the beam scanning element, other high-speed laser scanners can be used to scan the focal spots instead of the AOD. Nonexclusive examples of these include piezoelectric and galvanometer driven mirrors and rotating polygon mirrors.

In some implementations, besides the laser beam used for producing particle images, the image-guided particle sorting system also has an optical system for determining the particle speed (FIG. 6). In one example, the light source 602 for the speed determination optics may be a 455 nm LED. In this example, each flowing particle may be illuminated simultaneously by the LED 602 and one or more scanning lasers 101 and 102. As will be explained later, knowing the particle speed can be beneficial to reconstruct the particle images without distortions. Thus, a 455 nm LED may be used to measure the traveling speed of each particle and such information, i.e., travelling speed of each particle, will be utilized for particle image construction.

In some implementations, a microfluidic chip may be employed, which is configured with an on-chip piezoelectric PZT actuator to deflect selected particles in the microfluidic channel. The microfluidic chip may be structured to include a substrate having a passage forming a microfluidic sample channel, and microfluidic sheath channels that converge upon the sample channel. In some implementations, for example, the sample channel may be configured to carry particles (e.g., cells) suspended in a fluid that flows in a flow direction, and the sheath channels may be configured to provide sheath flow of fluid to hydrodynamically focus the suspended particles in the fluid prior to flowing through an illumination area of the microfluidic chip. In some embodiments, the particles may be focused using acoustics. In some embodiments, for example, the substrate can be formed in a bulk material, e.g., such as poly dimethyl siloxane (PDMS), that may be bonded to a base substrate, e.g., a glass base substrate or base substrate of other material.

In the example shown in FIG. 1, the image-guided particle sorting system further includes at least one of objective lenses 105 and 114 (e.g., of a microscope or other optical imaging device), light guide elements, first and second spatial masks 109 and, bandpass filters and, a high-speed photodetector 115, or a photomultiplier tube (PMT). In some implementations, the objective lenses 105 may be structured for both laser illumination and imaging to obtain high depth of focus across the particle thickness. In some implementations, the optical configuration of the image-guided particle sorting system includes one or more light guide elements, e.g., a dichroic mirror 107, for various purposes. For example, the dichroic mirror arranged with the laser light source and/or the LED light source may be configured to direct the input light at the illumination area of the microfluidic chip. Dichroic mirrors may be used to route the desired emission bands to the high-speed photodetector and the PMTs. In some embodiments, the photodetector may be a photodiode. The field of view may be determined by the frequency scanning range and deflection angle of AOD. In the optical setup, the field of view can be chosen to be, for example, 40 μm by 40 μm, which covers the size of most eucaryotic cells. In some embodiments the field of view may be 10 μm by 10 μm or smaller and enable viewing of bacteria or viruses. In some embodiments the field of view may be 100 μm by 300 μm which can visualize clumps of cells and spheroids. In some embodiments the field of view may be 1000 μm by 1000 μm. The resolution may be determined by the laser spot size. In the flow direction the resolution may be determined by the beam size, the flow speed, and the scanning rate.

In one embodiment, particle speed can be determined by measuring the time of passage of the particle past two detectors separated by a known distance. In some embodiments one or more of the speed detectors may be optical. In another embodiment one or more of the detectors measure impedance or other electrical signals.

In another embodiment, the speed of the particle may be determined by an optical system FIG. 6 using spatial masks 604. In such an example light from a light source 602 may pass the sample in the channel and the objective lens and then may be reflected by a first dichroic mirror and transmits through the first spatial mask 604 before reaching the high-speed photodetector 603 to produce a photocurrent. The first spatial mask may be structured to include two slits separated in the particle flow direction) and may be positioned at the image plane. Due to light scattering or absorption, the transmitted LED light through the slit produces a dip in the light intensity when a particle travels through the light path. The time interval between the two photocurrent dips produced by these two slits can be used to find the travel speed of the particle since the separation of the two slits and the magnification factor of the optical system may be known. The two parallel slits on the first spatial mask 112 placed may be 1 mm long each. The center-to-center distance between these two slits may be 200 μm.

The PMT output signals may be acquired and processed by a data processing and control unit such as an FPGA (Field Programable Gate Array) to make the sorting decision. In another embodiment, the analysis may be performed by a GPU, CPU, or combination of the three.

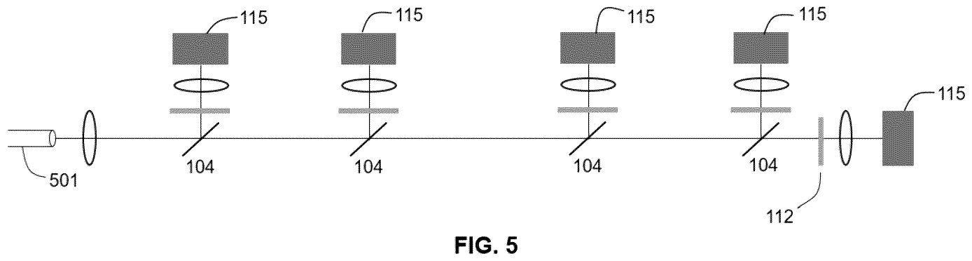

The number of PMTs included in the particle imaging system can be varied. For example, although FIG. 1 shows only 6 PMTs, 4 of which may be dedicated to epifluorescence and back scatter imaging. PMTs can be added to the imaging system, and if necessary, more excitation laser beams can be added to produce particle images. FIG. 5 shows an example of more PMTs being included by transmitting the fluorescent signal using a fiber optic cable 501. In some embodiments, the PMT may be replaced by a photodiode, avalanche photo detector, PMT array, CCD, and the like.

In some implementations, the particles may be flowing through channels in a substrate. In some examples, the flow channels split into 2 or more flow channels. In some embodiments, a piezoelectric PZT actuator may be actuated to sort particles into one of the 2 or more flow channels. In most embodiments, sorting actuation may be the result of an analysis of the detected particles as they passed the 2 or more co-linear scanning lasers.

### Image Construction

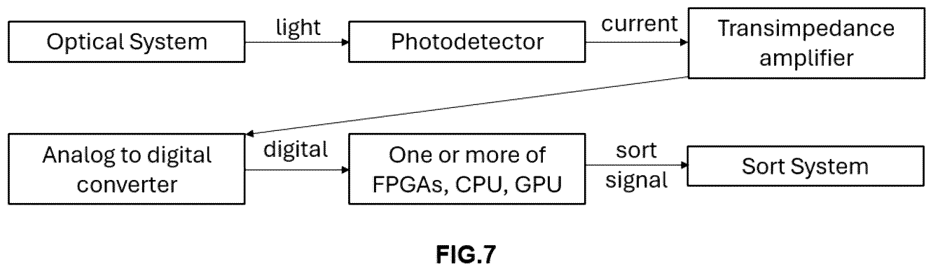

A data processing and control system of the particle sorting system may be configured in communication with the particle imaging system, e.g., via the photodetector, transimpedance amplifier, and analog to digital converter (FIG. 7) to rapidly process the imaged particles and produce a sorting control based on the processed image of each particle imaged in real-time. In some implementations of the data processing and control system, one or more FPGA, CPU, or GPU processing units may be configured to rapidly process the image signal data received by the particle-imaging system.

In some embodiments, the processing system generates a control signal for the AOD as a series of points, called ‘samples’, using a digital to analog converter (DAC). The processing system also acquires optical signals as a series of samples using an analog to digital converter (ADC). The timing of when the system generates a sample and when the system acquires a sample can be harmonically linked. For example, the instrument might generate 10 DAC samples for every 1 ADC sample. In that example, if the signal for the AOD for the first laser was 1 μs and 1250 samples and the signal for the second laser was also 1 μs and 1250 samples, and if the ADC sample rate was 125×10⁶ samples/second, the system would generate 2500 samples for the 2 signals. The first 125 samples would correspond to the particle's response to first laser and the next 125 samples would correspond to the second laser. In some embodiments, the scans for the two lasers may not be equal in length. In embodiments where the DAC samples may be not harmonically linked with the ADC samples, the processing system could use a signal from the AOD generation DAC to know which ADC samples correspond to when the first laser was scanning, and which ADC samples correspond to the second laser. Some samples from the beginning and end of the scans may be unusable and can be discarded. During those unusable periods, the instrument may output signals for both lasers 301.

Because the scanned laser lines produced by lasers 1 and 2 might not physically overlap, the processing system might need to shift one image relative to the other so that the corresponding pixels from a laser 1 image correspond to the same physical location on the particle of a laser 2 image.

The scan rate of the laser may be defined such that the fluorescent image data may be associated with the image data of the other lasers and LEDs that may be scanning. This may enable image construction to be performed using more signals than may be available without the interleaved AOD scanning system.

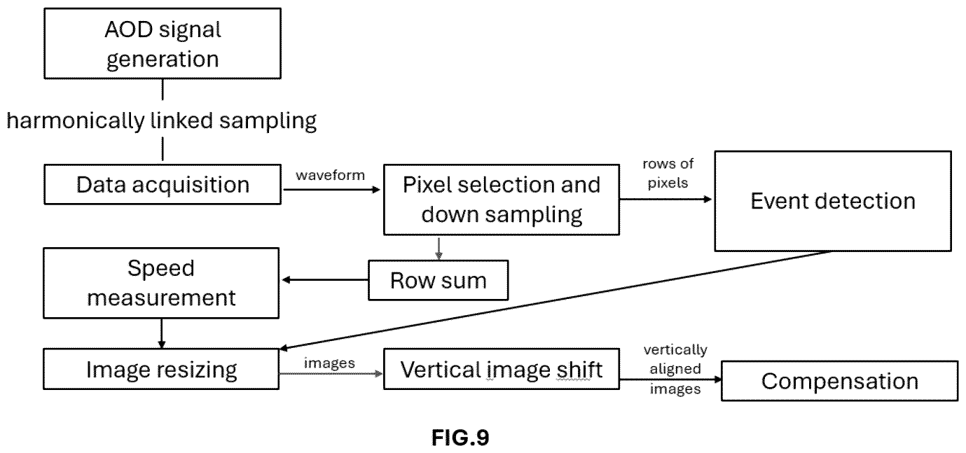

Image construction process in FIG. 9 may contain four steps: (1) synchronization of the AOD signal generation with the data acquisition so that the image of the particle is “in phase” with particle's position in the scan direction (2) Samples corresponding to different physical locations and different lasers can be selected to be included in the image and can be down sampled for example by simply averaging multiple (e.g. 2) consecutive ADC samples. This process results in rows of pixels that will later be assembled into images. (3) The image construction process applies an algorithm to the row pixel data to detect if a set of row pixels has a particle that should be analyzed. One such algorithm could be to sum one or more pixels across one or more rows and compare that sum to a threshold. If the sum is above the threshold, the rows may be sent to image resizing (4) Correction of image distortion due to the effect of particle travelling speed, which is referred to as “image resizing” as errors in particle speed measurements can result in contraction or stretch of the particle image.

### Image Resizing to Correct Image Distortion

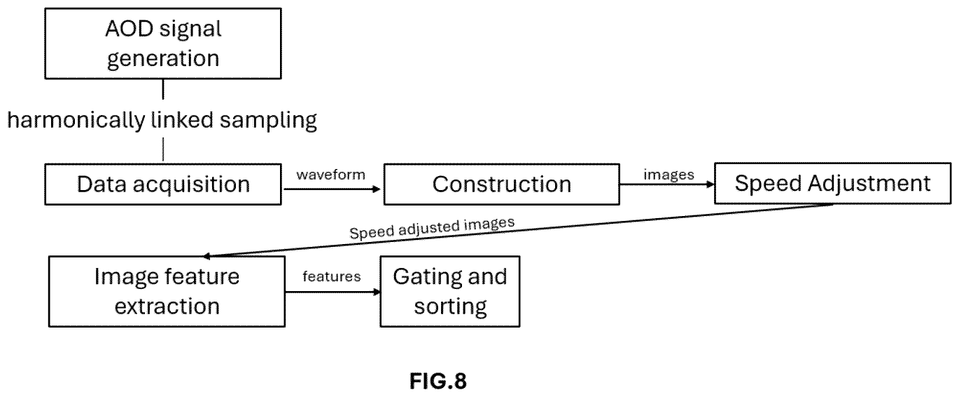

The data processing and control system of FIG. 8 and FIG. 9 may perform an image resizing operation so that the physical height and width represented by one pixel height and width may be equal for particles moving at different speeds. Without this correction, the extracted image data (e.g. area) would not accurately represent the particle's true size. For example, the pixel area for a particle moving slowly in the flow direction would be larger than if the same particle was moving quickly. Even with flow confinement, particles will not be at the same position in the cross section of the flow channel. For particles in a microfluidic channel with 2D instead of 3D flow confinement, the particle distance from the ceiling (or floor) of the channel can vary appreciably. In a laminal flow where particle speed may be determined by the particle position within the channel, the above effects can produce appreciable speed variations among particles. The process of image construction converts a temporal signal (detected by photodetectors) into a spatial signal. In making such conversion, particle-travelling speed determines how a certain time-period may be transformed into a certain length in space, hence variations in particle speed can affect the length scale and thus distort the particle image.

In some implementations, it may be considered that a particle moves at a speed v in the flow (z−) direction. For a time interval, At, which may be the time period of the sawtooth waveform, the laser spot scans through the y-axis and produces a train of signal: SZi(y1), SZi(y2) . . . SZi(yN). For the next scan occurring in the next period of At, another train of signal: SZi+1 (y1), SZi+1 (y2) ^Zi+1 (Tw) is produced where zi+1=zt+Az=zt+vAt

Assume an AOD operates at 400 kHz and each scan takes 2.5 μs (i.e. At=2.5 μs) and a particle travels at a speed of 20 cm/s, it is calculated that Az=vAt=0.5 μm/scan. Then the amount of time of taking 40 scans would cover a distance of Dzc40=20/μm, which defines the field of view (for 40 scans) along the flow direction (z-axis). However, if another particle travels through the optical interrogation area at a speed of 25 cm/s, Az=vAt becomes 0.625 μm/scan. Then over the same amount of time of taking 40 scans, the distance becomes 25 μm (0.625/rmx40=25/im) along the z-direction. Effectively, the field of view along the z-axis increases with the particle travel speed. If the travel speed of individual particles may be unknown and an average particle speed may be taken to construct particle images, then particles travelling faster than the average speed will appear to be smaller along the z-axis than their actual size, and particles travelling at lower than the average speed will appear to be larger than their actual size. Therefore, the process of resizing may be necessary to construct the particle image correctly without distortion.

From the above discussion, obviously one needs to know the travel speed of the particle, v, accurately to produce the correct particle image in the y-z plane. The instrument measures the speed by measuring the time between two signals of known distance apart. In some embodiments, the first of the two signals may be generated by detecting scattered light generated from the particle passing through an illuminated area before passing the scanned beam area. In some embodiments, the second signal may be generated from the scanned beam transmission signal. In some embodiments, the background signal from scanning will be subtracted to produce the second speed signal. In some embodiments, the signal will be averaged over the scan duration to produce the second speed signal. Once we have the speed signals, the instrument can determine the delay between the two signals. In some embodiments, we use the cross correlation between the two signals. The knowledge of speed, v, enables us to put the proper length scale in the z-direction to construct the particle image without distortion.

In some embodiments, the instrument applies the speed correction by resampling each column of the image using linear interpolation.

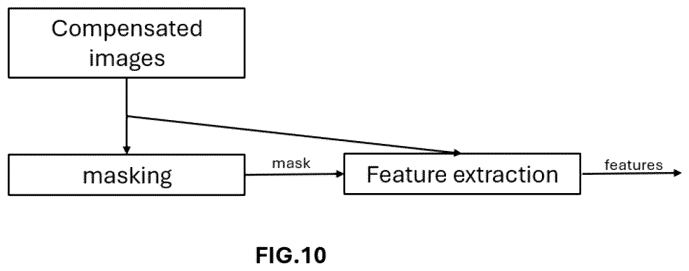

After image construction is completed, aspects of the images such as the particle area or perimeter (known as image feature data) may be extracted (FIG. 10). The image feature data can be used to trigger a sort signal to divert the particle (known as sorting).

1. A method for imaging of moving particles, comprising:
(i) moving a particle along a first direction;
(ii) generating a plurality of light beams from a plurality of lasers;
(iii) passing the plurality of light beams through a plurality of Acousto-Optic Deflectors (AODs), wherein each light beam passes through exactly one AOD;
(iv) deflecting the plurality of light beams with the plurality of AODs such that the plurality of light beams scan in a second direction at an angle to the first direction at a programable frequency; and
(v) scanning, the particle with a plurality of light beams, wherein only one light beam of the plurality of light beams illuminates a single location at a given time.

2. The method of claim 1, further comprising moving a plurality of apertures to block the plurality of beams when the plurality of beams not scanning the single point.

3. The method of claim 1, wherein each AOD of the plurality of AODs is individually programable to scan at a frequency.

4. The method of claim 3, wherein the frequency of the scan is at least 150 kHz.

5. The method of claim 3, wherein the frequency is an effective AOD frequency, wherein the effective AOD frequency is the sum of the frequency of each of the plurality of AODs.

6. The method of claim 5, wherein the effective AOD frequency is at least 300 kHz.

7. The method of claim 1, wherein the plurality of light beams comprises two or more lasers.

8. The method of claim 1, further comprising detecting optical signals of the plurality of light beams in a plurality of photodetectors.

9. The method of claim 8, further comprising processing the optical signals to create combined image data of the particle.

10. The method of claim 9, further comprising determining one or more properties associated with the particle from the processed combined image data.

11. The method of claim 9, wherein the optical signals are processed by performing an image resizing operation to correct an error caused by an effect of a travelling speed of the particle.

12. The method of claim 11, wherein a velocity of the particle moving in the first direction is determined using the optical signals.

13. The method of claim 1, wherein the plurality of light beams is generated by one or more passive optical components, selected from a group consisting of a cylindrical lens, a lens, a prism, a mirror, a dichroic element, and a spatial filter.

14. A particle sorting system, comprising:
(i) an imaging device comprising:
a first beam scanner configured to scan a first beam along a first direction to obtain a first particle image data comprising fluorescent information or label-free image information of a particle,
wherein the first beam is configured to be applied to the particle flowing in a channel along a second direction with an angle to the first direction; and
a second beam scanner configured to scan a second beam along the first direction to obtain a second particle image data comprising fluorescent information or label-free image information of the particle,
wherein the second beam is configured to be applied to the particle flowing in the channel along the second direction with the angle to the first direction,
wherein the first beam and the second beam are configured to be separately applied to the particle flowing in the channel;
(ii) a data processing and control device in communication with the imaging device, wherein the data processing and control device comprises a processor configured to process the first particle image data and the second particle image data obtained by the imaging device to determine one or more properties associated with the particle from the processed particle image data and to produce a control command based on a comparison of the determined one or more properties with a sorting criteria,
wherein the control command is configured to be produced during the particle flowing in the channel and is indicative of a sorting decision determined based on one or more particle attributes ascertained from the particle image data; and
(iii) a particle sorting device in communication with the imaging device and the data processing and control device,
wherein the particle sorting device comprises one or more output paths branching from the channel in which the particle flows, and wherein the particle sorting device is configured to direct the particle into one of the one or more output paths based on the control command.

15. The particle sorting system of claim 14, wherein the first beam scanner and the second beam scanner comprise a first Acousto-Optic Deflector (AOD) beam scanner and a second Acousto-Optic Deflector (AOD) beam scanner.

16. The particle sorting system of claim 15, wherein the first AOD beam scanner and the second AOD beam scanner are operatively coupled with a first laser light source and a second laser light source, wherein the first AOD beam scanner and the second AOD beam scanner are configured to direct an input light toward the particle in the channel.

17. The particle sorting system of claim 14, wherein the imaging device further comprises an aperture operable to block the first beam or the second beam.

18. The particle sorting system of claim 16, wherein the first AOD and the second AOD are separably programmable, by the data processing unit, to generate a first scanning frequency and a second scanning frequency.

19. The particle sorting system of claim 18, wherein the first scanning frequency or second scanning frequency are about 1000 kHz.

20. The particle sorting system of claim 16, wherein the first AOD and the second AOD are programmable, by the data processing unit, to generate combined scanning frequency of about 500 kHz to 30 kHz.

21.-26. (canceled)
